(19) United States
(12) Patent Application Publication
(10) Pub. No.: US 2016/0375287 A1
(43) Pub. Date: Dec. 29, 2016

(54) FIRE-SPRINKLER PROTECTION SYSTEM AND METHOD FOR A COMBUSTIBLE CONCEALED SPACE

(71) Applicant: Stephen J. MEYER, Chester Springs, PA (US)

(72) Inventor: Stephen J. MEYER, Chester Springs, PA (US)

(73) Assignee: Globe Fire Sprinkler Corporation, Standish, MI (US)

(21) Appl. No.: 15/191,073

(22) Filed: Jun. 23, 2016

Related U.S. Application Data
(60) Provisional application No. 62/183,526, filed on Jun. 23, 2015.

(51) Int. Cl. A62C 35/60; B05B 1/26

(52) U.S. Cl. CPC A62C 35/60; B05B 1/265

(57) ABSTRACT

A fire-sprinkler protection system for a combustible concealed space having a sloped ceiling has a plurality of fire-sprinklers including pendent sprinklers and sidewall sprinklers disposed beneath the sloped ceiling. Each pendent sprinkler provides a spray pattern that is generally circular cylindrical about the sprinkler. Each sidewall sprinkler provides a spray pattern that is generally rectangular in shape. The hydraulic demand for each sprinkler is substantially equivalent to the projection hydraulic demand for the horizontal footprint projection of the sloped ceiling on the floor. A piping system is coupled to each sprinkler by a plurality of branch lines is sized to provide the hydraulic demand for each sprinkler.

### CROSS-REFERENCE TO RELATED APPLICATIONS

This application is related to U.S. Provisional Patent Application No. 62/183,526, filed Jun. 23, 2015 and incorporated herein by reference, and claims the earlier filing date of the provisional application.

### BACKGROUND OF THE INVENTION

The present invention relates to a fire-sprinkler protection system and method for a combustible concealed space. More particularly, the present invention relates to a fire-sprinkler protection system for a combustible concealed space having a floor with a protection area less than about three-thousand square feet above which a sloped ceiling has a pitch of three in twelve or greater.

U.S. Pat. No. 8,083,002 B1 describes an upright fire protection sprinkler designed for the special application of protection of combustible concealed spaces of certain wood construction with certain minimum roof pitches that avoids the coverage penalty imposed by code (e.g., National Fire Protection Association 13: Standard for the Installation of Sprinkler Systems (2016 Edition), hereafter referred to as “NFPA 13”) on standard spray sprinklers used in such applications.

U.S. Pat. No. 8,151,897 B1 describes a sidewall fire protection sprinkler designed for a spray pattern of water droplets with a distribution effective to control an ordinary hazard fire in a coverage area imposed by NFPA 13.

For certain reasons, it would be desirable to have a pendent sprinkler and a sidewall sprinkler approved for combustible concealed space while also avoiding the coverage penalties of standard spray sprinklers. To date no such sprinklers have been shown to exist and perform equivalently to the upright sprinkler in U.S. Pat. No. 8,083,002 for concealed space protection.

### BRIEF SUMMARY OF THE INVENTION

Briefly stated, one embodiment of the present invention is directed to a fire-sprinkler protection system for a combustible concealed space having a floor with a sloped ceiling with a pitch of three in twelve or greater. The fire-sprinkler protection system has a plurality of pendent sprinklers disposed beneath the sloped ceiling. Each pendent sprinkler of the plurality of pendent sprinklers has a pendent-sprinkler deflector providing a pendent-sprinkler spray pattern that is generally circular cylindrical about the pendent sprinkler and a pendent-sprinkler hydraulic demand substantially equivalent to a projection hydraulic demand for a horizontal footprint projection of the sloped ceiling on the floor. A plurality of sidewall sprinklers is disposed at structural points of maximum heat trap. A sidewall-sprinkler deflector provides a sidewall-sprinkler spray pattern having a generally rectangular shape. The sidewall-sprinkler hydraulic demand is substantially equivalent to the projection hydraulic demand for the horizontal footprint projection of the sloped ceiling on the floor. A piping system is coupled to each pendent sprinkler of the plurality of pendent sprinklers and each sidewall sprinkler of the plurality of sidewall sprinklers by a plurality of branch lines. The piping system is sized to provide each pendent sprinkler of the plurality of pendent sprinklers with the pendent-sprinkler hydraulic demand and to provide each sidewall sprinkler of the plurality of sidewall sprinklers with the sidewall-sprinkler hydraulic demand.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, the drawings show embodiments which are presently preferred. It should be understood, however, that the invention is not limited to the precise arrangements and instrumentalities shown.

In the drawings:

FIG. 1 is a schematic elevation view of a system having a suggested staggered sprinkler spacing;

FIG. 1A is a schematic plan view of the system of FIG. 1 illustrating the suggested staggered sprinkler spacing;

FIG. 1B is a schematic plan view of the preferred system of FIG. 1 illustrating the suggested staggered sprinkler spacing for a hipped roof;

FIGS. 2 is an elevational view of a pendent sprinkler for use in the system of FIGS. 1-1B;

FIGS. 3-3A are an elevation and plan schematic of the spray pattern of a system of conventional, standard spray upright sprinklers arranged in a typical grid spacing;

FIGS. 4-4A are partial elevation and plan schematics of the spray pattern of the described sprinkler system of FIGS. 1-1A;

FIG. 5 is a side cross sectional view of a preferred embodiment of sidewall sprinkler for use in the system of FIGS. 1-1B; and

FIG. 6 is a schematic of a preferred method of installing the system of FIG. 1.

### DETAILED DESCRIPTION OF THE INVENTION

Reference will now be made in detail to embodiments of the invention, examples of which are illustrated in the accompanying drawings. The terminology used in the description of the invention herein is for the purpose of describing particular embodiments only and is not intended to be limiting of the invention.

As used in the description of the invention and the appended claims, the singular forms “a”, “an” and “the” are intended to include the plural forms as well, unless the context clearly indicates otherwise. The words “and/or” as used herein refers to and encompasses any and all possible combinations of one or more of the associated listed items. The words “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The words “right,” “left,” “lower” and “upper” designate directions in the drawings to which reference is made. The words “inwardly” and “outwardly” refer to directions toward and away from, respectively, the geometric center of the fire-sprinkler protection system, and designated parts thereof. The terminology includes the words noted above, derivatives thereof and words of similar import.

Although the words first, second, etc., are used herein to describe various elements, these elements should not be limited by these words. These words are only used to distinguish one element from another. For example, a first pair could be termed a second pair, and, similarly, a second pair could be termed a first pair, without departing from the scope of the present invention.

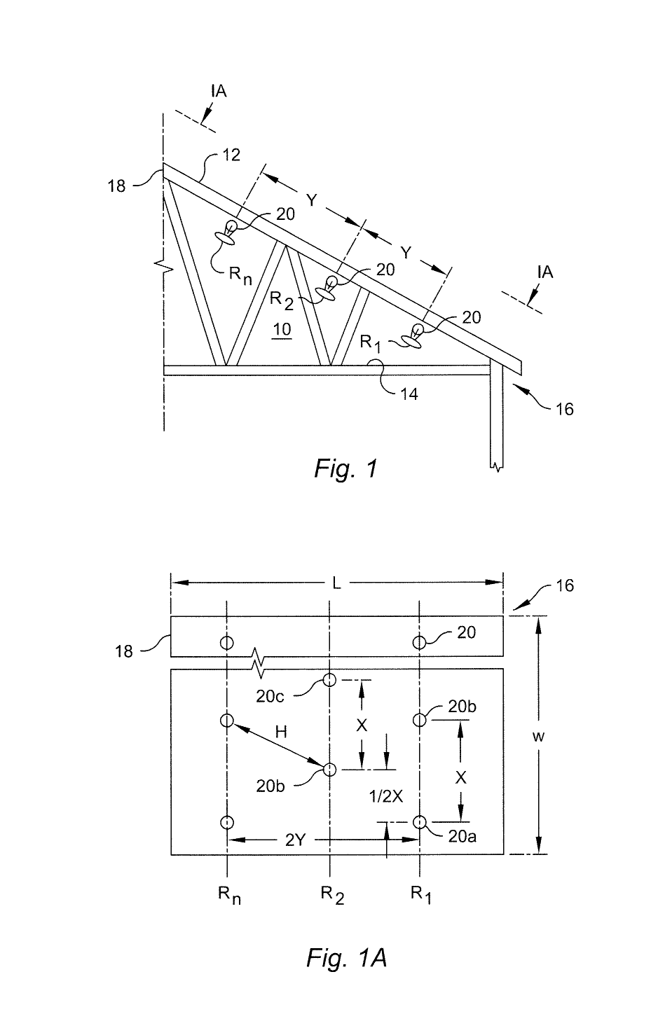

Shown in FIGS. 1-1B are schematic embodiments of methods for providing fire protection to an attic space, for example, a non-combustible or combustible concealed space beneath a roof. The preferred method includes locating a plurality of specific application pendent sprinklers, preferably four or more, spaced about a sloped ceiling having a slope of 3 in 12 or greater. The methods provide adequate fire protection to the concealed spaces, yet avoids the hydraulic design penalties imposed by NFPA 13 for the design of a standard spray sprinkler system beneath a sloped ceiling.

Shown in FIG. 1 is an elevation view of a concealed space 10 defined as existing between a roof (or ceiling) 12 and a floor 14. The concealed space conditions can be configured, as provided in NFPA 13, 2016 Edition, Chapter 8, Section 8.6, including Table 8.6.2.2.1(a) and FIG. 8.6.4.1.4 which is incorporated by reference in its entirety, as an attic beneath the roof 12 with the combustible concealed space 10 being of wood joist or wood truss construction with truss members three feet or less on center. The roof 12 preferably extends between an eave 16 and a ridge 18 on an incline so as to define a slope having a pitch of 3 in 12 or greater.

As shown in FIGS. 1-4A, a preferred embodiment of the fire-sprinkler protection system is for a combustible concealed space 10 having a floor 14 above which is a sloped roof (or ceiling) 12 having a pitch equal to or greater than three in twelve. The fire-sprinkler protection system has a plurality of sprinklers 20 disposed beneath the sloped ceiling as further describer below. A piping system (not shown) is coupled to each sprinkler of the plurality of sprinklers by a plurality of branch lines. The piping system is sized to provide each sprinkler with a hydraulic demand substantially equivalent to a projection hydraulic demand for a horizontal footprint projection of the sloped ceiling on the floor.

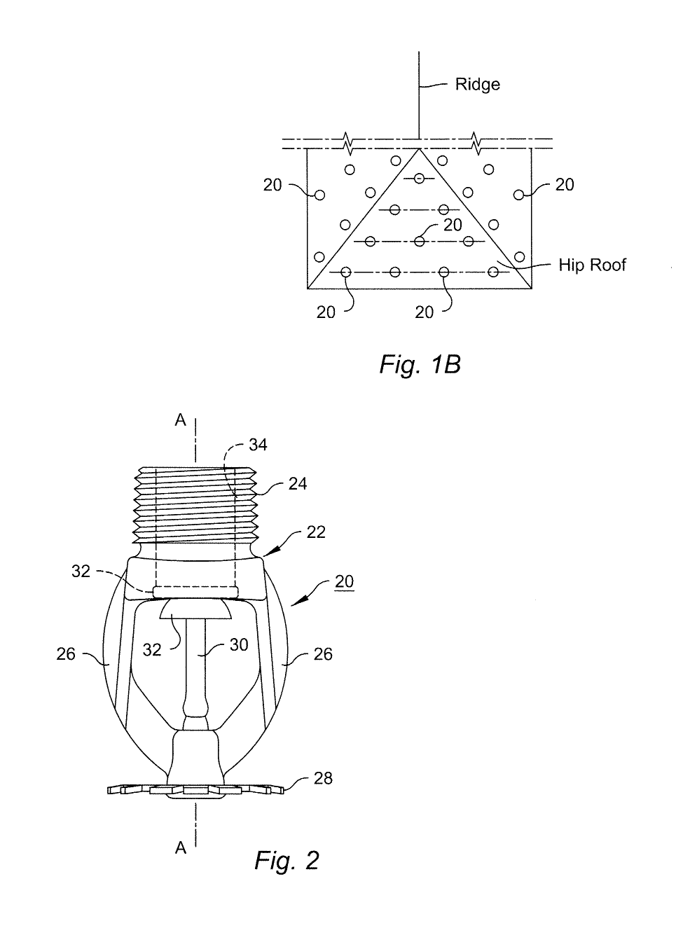

Disposed beneath the roof 12 are one or more rows of sprinklers 20 spaced relative to one another along the slope in a line perpendicular to the slope, typically parallel to the roof 12. The sprinklers 20 are preferably combustible concealed spaced specific application pendent sprinklers. Shown in FIG. 2 is an elevation view of the special application pendent sprinkler 20 of the present invention, which is based, in general, upon a GLOBE Fire Sprinkler Corporation Model GL 5610 Pendent Sprinkler. The pendent sprinkler 20 includes a frame 22 with a threaded inlet end 24 for coupling to a branch line of a water piping system. A passageway 34 (in phantom) is defined through the inlet end 24 of the frame 22 leading to a pair of frame arms 26 of the frame 22 that extend distally to support a deflector 28 disposed along a sprinkler central axis A-A that extends from the inlet end 24 centrally through the frame 22 and passageway 34 and the deflector 28. The deflector 28 is a substantially planar, circular member having a plurality of slots extending radially inwardly from an outer perimeter and defining a plurality of tines there between. In the suggested installation of the sprinkler 20 beneath the roof 12, the sprinkler axis A-A is preferably perpendicular to the facing sloped surface of the roof 12 such that the deflector 28 is substantially parallel to the slope of the roof 12.

Actuation of the sprinkler 20 is controlled by a thermally sensitive fusible element 30, such as a bulb, metal solder or equivalents thereof, which supports a seal assembly 32 (partially in phantom) disposed in the passageway 34 to control fluid discharge from the sprinkler 10. The sprinkler 20 and its fusible element 30 are preferably rated for 200° F. although other conventional temperature ratings (e.g. 155° F. or 175° F.) might be considered. Upon exposure to a sufficient level of heat, the fusible element 30 breaks away to actuate the sprinkler and release the seal assembly 32. Fluid is discharged from the sprinkler outlet to impact the deflector 28 for distribution over the protection area. The sprinkler 20 and its deflector 28 define a substantially circular spray pattern in which water deflects off the peripheral edge of the deflector substantially in a plane parallel to the plane of the deflector 28 and thus to the slope of the roof.

The sprinkler 20 and its deflector 28 provide a coverage area of about 120 square feet (a circular area with a radius of about 6 feet). Moreover, with an operating pressure of 7 psi, passageway K-Factors of 4.2 gpm/(psi)^{1/2} or 5.6 gpm/(psi)^{1/2} define respective flow rates of about 11 gpm and nearly 15 gpm. Larger K-Factors could be employed.

Referring again to FIG. 1, the first row R1 along the eave 16 of sprinklers is preferably, but not necessarily, located in accordance with NFPA 13 Paragraph 8.6.4.1.4.3 so as to be spaced from the eave no further than one-half an allowed distance between sprinklers as measured parallel with the slope. Preferably, but not necessarily, the rows R1, R2 . . . Rn are spaced in the direction of the slope at a maximum row-to-row spacing ranging from a distance Y of about ten feet to about twelve feet (10 ft.-12 ft.). However, other distances may be possible. FIG. 1A is a plan view of the concealed space 10 with the spaced apart rows of sprinklers 20. For any given row Rx, the sprinklers 20 are preferably, but not necessarily, horizontally linearly and evenly spaced along the length of the eave 16 perpendicular to the slope. The sprinklers 20 are further preferably linearly spaced from one another at a distance X along the row at distance X of between about seven and ten feet (7 ft. and 10 ft.).

Referring again to FIG. 1A, shown is the horizontal footprint projection of the sloped roof 12 onto the floor 14 which defines the protection area 10 having a length L and a width W.

Disposed over the area 10 is the preferred array of sprinklers 20. According to the preferred method, where there is more than one row R required, the sprinklers may be staggered. More specifically, for a first row R1 having at least two sprinklers 20a and 20b spaced apart at a distance X along the row R1, an adjacent second row R2 has at least two sprinklers 20b and 20c spaced apart at a distance X where one of the two sprinklers of the second row R2 is aligned in the direction of the slope and staggered between the at least two sprinklers 20a and 20b of the first row R1 such that adjacent rows of sprinklers are offset and not necessarily aligned. Shown in FIG. 1B is an alternative schematic embodiment of the preferred staggered method in which the sloped roof 12 is in a HIPPED roof system.

In a more specific alternative method of protection, sprinklers 20 are spaced at a distance X every five feet (5 ft.) and the rows are spaced apart a distance Y every ten feet (10 ft.) between sprinklers. Accordingly, positioned between every two sprinklers of one row is a sprinkler 20 on an adjacent row.

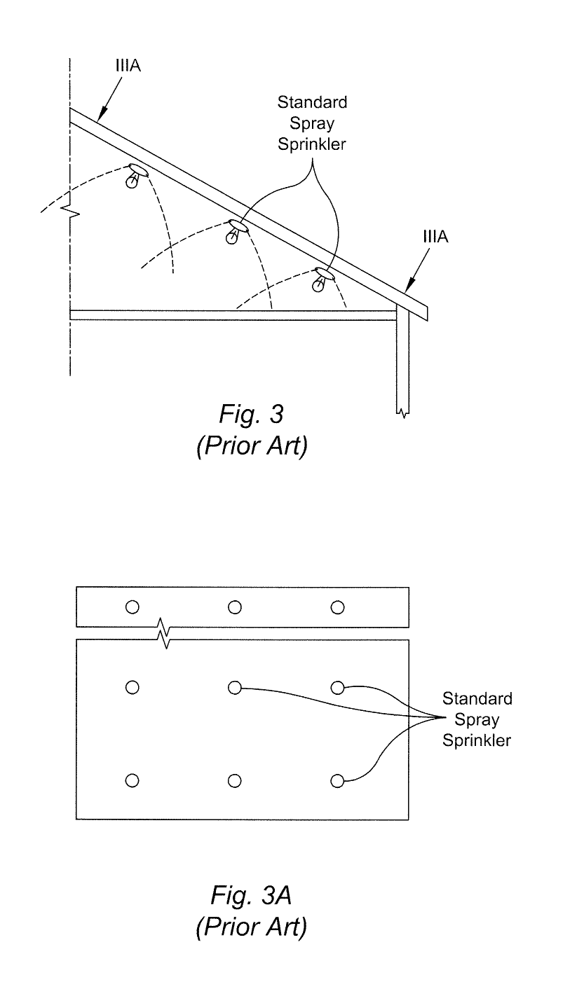

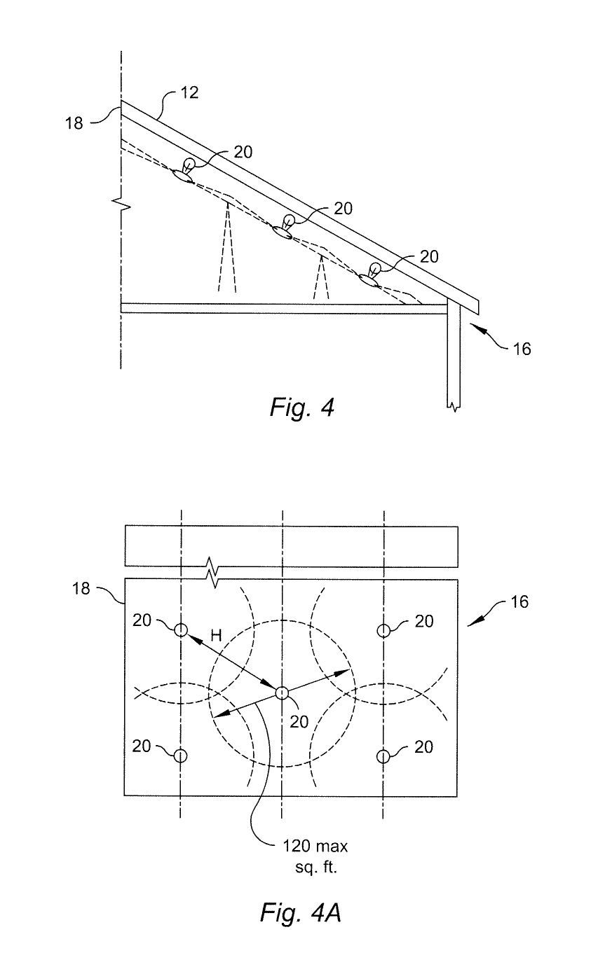

FIGS. 3 and 3A depict the conical spray pattern and standard installation layout of standard spray sprinklers which create v-shaped voids between overlapping patterns and the roof 12 through which heat and flames can travel. The preferred sprinklers 20 however minimize such voids because, the circular planar spray pattern of the sprinklers 20, each having a coverage area of about one hundred twenty square feet (120 sq. ft.), overlap one another as schematically illustrated in FIG. 4A without formation of v-shaped voids as shown in FIG. 4. The described method of staggered sprinkler spacing seeks to minimize or otherwise eliminate the possibility that heat from a fire would progress up the sloped roof 12 to the ridge 18 without activation of at least one sprinkler 20. In addition, the described method of staggering the sprinklers 20 places the sprinkler-to-sprinkler centers a sufficient distance apart H, as seen schematically in FIGS. 1A and 4A, so as to minimize or eliminate the possibility of cold soldering of adjacent sprinklers.

Once the layout (numbers and locations) of the sprinklers 20 is defined for protection of the concealed space 10 in question, the hydraulic demand of those sprinklers 20 must be determined. Suggestedly, the hydraulic demand is determined using the Density/Area curve for light hazard as shown in FIG. 11.2.3.1.1 of NFPA-13, 2016 Edition, which is incorporated by reference in its entirety. According to the curve, the hydraulic density requirement is 0.10 gpm/sq. ft. for a sprinkler operational or coverage area of 1500 SQ. FT. or less. For the preferred method and arrangement of sprinklers 20, the hydraulic demand of the sprinklers 20 to be satisfied is the hydraulic demand of just the protection area, or more specifically, the density requirement, i.e., 0.10 gpm/sq. ft. multiplied by the hydraulic design or protection area or, more specifically, the horizontal foot print of the sloped roof and the protection area of the sprinklers 20. The preferred method of fire protection using the pendent sprinklers 20 does not require that the hydraulic design area be increased by thirty percent to account for the sloped roof, as provided in NFPA-13, 2016 Edition, Section 11.2.3.2.4. Use of special application pendent sprinklers provides for a concealed space fire protection system that eliminates current hydraulic design “penalties” imposed for standard spray sprinklers under sloped ceilings and thereby reduces the water demand required by such standard spray sprinklers under the current sloped ceiling design standards. The system is provided by the method of locating at least one special application pendent sprinkler 20 coupled to a pipe system and having a deflector beneath the roof and parallel to its slope and defining a hydraulic demand of the at least one sprinkler as being equivalent to a hydraulic demand for the protection area projected beneath the sprinkler, thus eliminating any current “penalty” for designing a standard spray system installed for fire protection beneath a sloped roof or ceiling. Accordingly, the subject method provides that the hydraulic demand of the special application pendent sprinklers is satisfied by the hydraulic demand of just the protection area, or more specifically, the density requirement multiplied by the horizontal foot print of the sloped roof 12.

In the case where there is more than one row of sprinklers 20, the staggered sprinkler configuration of the special application pendent sprinklers in the subject combustible concealed space fire protection system presents a protection area having a hydraulic demand that is at least equal to that of a standard spray sprinkler configuration under a flat ceiling. Thus, the preferred system eliminates the need to design the system with a thirty percent increase in the calculated operational area beneath a sloped ceiling.

The methods described herein are applicable to a preferred combustible concealed space fire protection system configured as a wet pendent system. Thus the sprinklers can be installed and located in a method as described above for coupling to a wet pipe system.

The hydraulic demand calculations for the subject system are a function of only the area being protected by the preferred specific application pendent sprinklers, regardless of whether other areas are being protected by standard spray sprinklers or other forms of specific application attic sprinklers. For example, where the special application pendent sprinklers of the present invention are arranged to cover a minimum protection area of say 1000 square feet (projected area of the sloped roof), the hydraulic demand calculation for the 1000 square foot area protected by the special application pendent sprinklers would use the density/area method of Chapter 11 in NFPA-13 for light hazard, and only require an accounting of only the 1000 square foot area protected by the special application pendent sprinklers of the present invention and not any area protected by other sprinklers.

Where the sprinkler spacing in a direction perpendicular to the slope of the ceiling or roof is greater than eight feet (8 ft.), the minimum operating pressure for each preferred pendent sprinkler in the system will be less than twenty pounds per square inch. Currently, under NFPA-13 at Table 8.6.2.2.1(a), which is incorporated by reference in its entirety, the minimum pressure for such spacing and concealed space configuration of standard spray sprinklers is 20 psi. The presently described pendent sprinkler concealed space protection system defines a minimum operating pressure of less than 20 psi. in which the pendent sprinklers have a sprinkler-to-sprinkler spacing greater than 8 feet in a direction perpendicular to the slope.

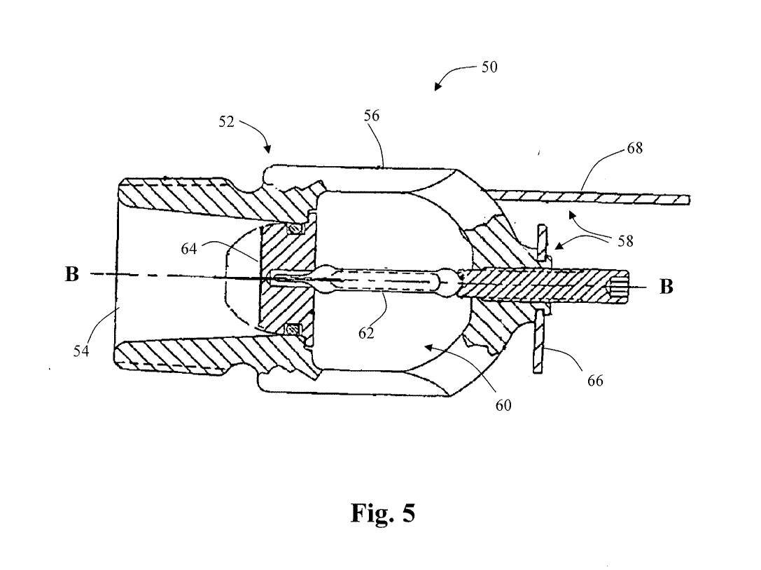

In some embodiments of the foregoing fire-sprinkler protection system the sprinklers 20 may include a plurality of extended coverage sidewall spray sprinklers 50 (see FIG. 5) configured as provided in NFPA 13 Chapter 8, Section 8.9, which is incorporated herein by reference in its entirety. Preferably each sidewall sprinkler 50 of the plurality of sidewall sprinklers, has a sidewall-sprinkler hydraulic demand substantially equivalent to the projection hydraulic demand for the horizontal footprint projection of the sloped ceiling 12 on the floor 14.

Referring to FIG. 5, each sidewall sprinkler 50, which is preferably based upon a Globe Fire Sprinkler Corporation Model GL5628 Extended Coverage Horizontal Sidewall Sprinkler, has a sidewall-sprinkler frame 52 with a threaded sidewall-sprinkler inlet end 54 coupled to one of the branch lines of the piping system (not shown). A pair of sidewall-sprinkler frame arms 56 extend from the sidewall-sprinkler frame 52 and support a sidewall-sprinkler deflector 58 disposed along a sidewall-sprinkler central axis B-B that extends from the inlet end 54 centrally through the sidewall-sprinkler frame 52. A sidewall-sprinkler passageway 60 extends through the sidewall-sprinkler inlet end 54 of the sidewall-sprinkler frame 52. A sidewall-sprinkler actuator 62, substantially the same as the actuator 30 for the pendent sprinkler 20 discussed above supports a sidewall-sprinkler seal assembly 64 dispose in the sidewall-sprinkler passageway 60 and controls fluid discharge from the sidewall sprinkler 50.

The sidewall-sprinkler deflector 58 supported by the pair of sidewall-sprinkler frame arms 56 has a substantially planar face portion 66 perpendicular to the sidewall-sprinkler central axis B-B and a canopy portion 68 extending generally horizontally over the face portion 66. The sidewall-sprinkler deflector 58 provides a sidewall-sprinkler spray pattern having a generally rectangular shape.

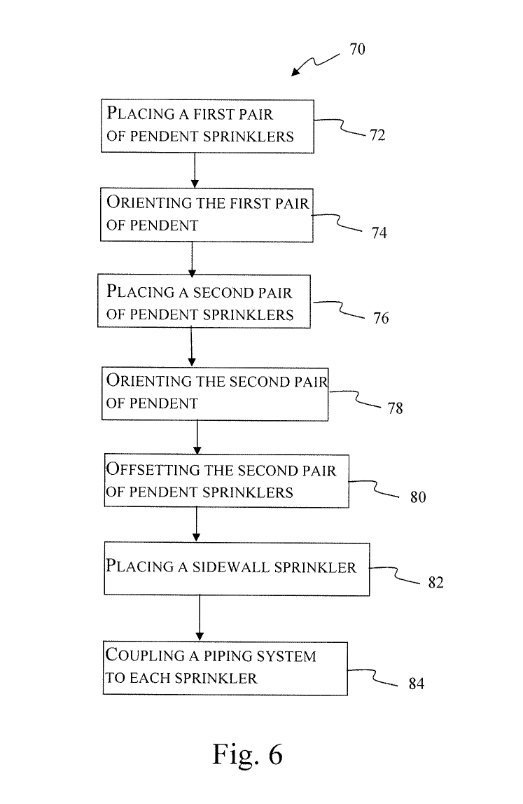

Referring to FIG. 6, in a preferred installation method 70 of the fire-sprinkler protection system, in a first step 72, a first pair of pendent sprinklers 20a of a plurality of pendent sprinklers 20 is placed beneath the sloped ceiling 12 and spaced a first distance apart along a first row perpendicular to a direction of the slope of the ceiling 12

In a second step 74 the at least the first pair of pendent sprinklers 20a is oriented such that the pendent-sprinkler central axis A-A extending from the pendent-sprinkler inlet end 24 centrally through the pendent-sprinkler frame 22 and the pendent-sprinkler deflector 28 is perpendicular to the direction of the slope of the ceiling 12.

In a third step 76 at least a second pair of pendent sprinklers 20b of the plurality of pendent sprinklers 20 is placed beneath the sloped ceiling 12 and spaced a second distance apart along a second row perpendicular to the direction of the slope, the second row being spaced parallel to the first row.

In a fourth step 78, the at least a second pair of pendent sprinklers 20b is oriented such that the pendent-sprinkler central axis A-A is perpendicular to the direction of the slope of the ceiling 12.

In a fifth step 80, the at least second pair of pendent sprinklers 20b is offset from the at least first pair of pendent sprinklers 20a such that in the direction of the slope, one pendent sprinkler of the second pair 20b is aligned at a staggered distance between the at least first pair of pendent sprinklers 20a to satisfy a pendent-sprinkler hydraulic demand.

In a sixth step 82, at least one sidewall sprinkler 50a of the plurality of sidewall sprinklers 50 is disposed beneath the sloped ceiling at a structural point of maximum heat trap such that a canopy portion 68 of the sidewall-sprinkler deflector 58 is generally parallel to the ceiling 12.

In a seventh step 84, a piping system is coupled to each sprinkler 20a, 20b, 50 is by a plurality of branch lines sized to provide each sprinkler with the hydraulic demand substantially equivalent to a projection hydraulic demand for a horizontal footprint projection of the sloped ceiling on the floor.

The foregoing detailed description of the invention has been disclosed with reference to specific embodiments. However, the disclosure is not intended to be exhaustive or to limit the invention to the precise forms disclosed. Those skilled in the art will appreciate that changes could be made to the embodiments described above without departing from the broad inventive concept thereof. Therefore, the disclosure is intended to cover modifications within the spirit and scope of the present invention as defined by the appended claims.

All references and patents mentioned above are incorporated herein by reference in their entirety and are not to be construed as an admission that any of the cited documents constitutes prior art, or as an admission against interest in any manner.

We claim:

1. A fire-sprinkler protection system for a combustible concealed space above which is a sloped ceiling with a pitch greater than one in twelve, the fire-sprinkler protection system comprising:
a plurality of pendent sprinklers disposed beneath the sloped ceiling, each pendent sprinkler of the plurality of pendent sprinklers having a pendent-sprinkler deflector providing a pendent-sprinkler spray pattern that is generally circular cylindrical about the pendent sprinkler, and a pendent-sprinkler hydraulic demand substantially equivalent to a projection hydraulic demand for a horizontal footprint projection of the sloped ceiling on the floor,
a plurality of sidewall sprinklers disposed at structural points of maximum heat trap, each sidewall sprinkler of the plurality of sidewall sprinklers having a sidewall-sprinkler deflector providing a sidewall-sprinkler spray pattern having a generally rectangular shape and a sidewall-sprinkler hydraulic demand substantially equivalent to the projection hydraulic demand for the horizontal footprint projection of the sloped ceiling on the floor; and
a piping system coupled to each pendent sprinkler of the plurality of pendent sprinklers and each sidewall sprinkler of the plurality of sidewall sprinklers by a plurality of branch lines, the piping system sized to provide each pendent sprinkler of the plurality of pendent sprinklers with the pendent-sprinkler hydraulic demand and to provide each sidewall sprinkler of the plurality of sidewall sprinklers with the sidewall-sprinkler hydraulic demand.

2. The fire-sprinkler protection system according to claim 1, wherein each pendent sprinkler further comprises:
a pendent-sprinkler frame having a threaded pendent-sprinkler inlet end coupled to one of the branch lines of the piping system;
a pair of pendent-sprinkler frame arms extending from the pendent-sprinkler frame and supporting the pendent sprinkler deflector which is disposed along a pendent-sprinkler central axis A-A that extends from the pendent-sprinkler inlet end centrally through the pendent-sprinkler frame;
a pendent-sprinkler passageway 34 through the pendent-sprinkler inlet end of the pendent-sprinkler frame; and
a pendent-sprinkler actuator supporting a pendent-sprinkler seal assembly dispose in the pendent-sprinkler passageway, the pendent-sprinkler actuator controlling fluid discharge from the pendent sprinkler, and
wherein each sidewall sprinkler further comprises:
a sidewall-sprinkler frame with a threaded sidewall-sprinkler inlet end coupled to one of the branch lines of the piping system;
a pair of sidewall-sprinkler frame arms extending from the sidewall-sprinkler frame and supporting the sidewall-sprinkler deflector disposed along a sidewall-sprinkler central axis B-B that extends from the inlet end centrally through the sidewall-sprinkler frame;
a sidewall-sprinkler passageway through the sidewall-sprinkler inlet end of the sidewall-sprinkler frame; and
a sidewall-sprinkler actuator supporting a sidewall-sprinkler seal assembly dispose in the sidewall-sprinkler passageway, the sidewall-sprinkler actuator controlling fluid discharge from the sidewall sprinkler.

3. The fire-sprinkler protection system according to claim 2, wherein the pendent-sprinkler actuator and the sidewall-sprinkler actuator are thermally sensitive.

4. The fire-sprinkler protection system according to claim 1, wherein the pendent-sprinkler deflector is a substantially planar, circular member having a plurality of slots extending radially inwardly from an outer perimeter and defining a plurality of tines there between and the sidewall-sprinkler deflector has a substantially planar face portion perpendicular to the sidewall-sprinkler central axis B-B that extends from the sidewall-sprinkler inlet end centrally through the sidewall-sprinkler frame and a canopy portion extending generally horizontally over the face portion.

5. The fire-sprinkler protection system according to claim 1, wherein each pendent sprinkler has a pendent-sprinkler central axis A-A extending from the pendent-sprinkler inlet end centrally through the pendent-sprinkler frame and the deflector, and the plurality of pendent sprinklers are disposed beneath the sloped ceiling such that the pendent-sprinkler central axis A-A is perpendicular to a direction of the slope of the ceiling, and the deflector is substantially parallel to the direction of the slope of the ceiling and wherein each sidewall sprinkler has a sidewall-sprinkler central axis B-B that extends from the sidewall-sprinkler inlet end centrally through the sidewall-sprinkler frame and the plurality of sidewall sprinklers are disposed beneath the sloped ceiling such that a canopy portion of the sidewall-sprinkler deflector is generally parallel to the ceiling.

6. The fire-sprinkler protection system according to claim 1, wherein at least a first pair of the plurality of pendent sprinklers disposed beneath the sloped ceiling are spaced apart a first distance along a first row perpendicular to a direction of the slope of the ceiling, and wherein at least a second pair of the plurality of pendent sprinklers disposed beneath the sloped ceiling are spaced apart a second distance along a second row perpendicular to the direction of the slope of the ceiling, the second row being spaced parallel to the first row, the at least second pair of pendent sprinklers being offset from the first pair of pendent sprinklers such that in the direction of the slope, one pendent sprinkler of the second pair is staggered between the first pair of pendent sprinklers to satisfy the pendent-sprinkler hydraulic demand and wherein each sidewall-sprinkler has a sidewall-sprinkler central axis B-B that extends from the sidewall-sprinkler inlet end centrally through the sidewall-sprinkler frame and the plurality of sidewall sprinklers are disposed beneath the sloped ceiling such that a canopy portion of the sidewall-sprinkler deflector is generally parallel to the ceiling.

7. The fire-sprinkler protection system according to claim 1, wherein the piping system is a wet piping system

8. A method for installing the fire-protection system of claim 1 comprising the steps of:
placing beneath the sloped ceiling at least a first pair pendent sprinklers of the plurality of pendent sprinklers spaced a first distance along a first row perpendicular to a direction of the slope of the ceiling;
orienting the at least the first pair of pendent sprinklers such that a pendent-sprinkler central axis A-A extending from a pendent-sprinkler inlet end centrally through a pendent-sprinkler frame and the pendent-sprinkler deflector is perpendicular to the direction of the slope of the ceiling,
placing beneath the sloped ceiling at least a second pair of pendent sprinklers of the plurality of pendent sprinklers spaced a second distance apart along a second row perpendicular to the direction of the slope, the second row being spaced parallel to the first row;
orienting the at least a second pair of pendent sprinklers such that the pendent-sprinkler central axis A-A extending from the pendent-sprinkler inlet end centrally through the pendent-sprinkler frame and the pendent-sprinkler deflector is perpendicular to the direction of the slope of the ceiling;
offsetting the at least second pair of pendent sprinklers from the first pair of pendent sprinklers such that in the direction of the slope, one pendent sprinkler of the second pair is staggered between first pair of pendent sprinklers to satisfy a pendent-sprinkler hydraulic demand;
placing at least one of the sidewall sprinkler of the plurality of sidewall sprinklers such that the at least one sidewall sprinkler is disposed beneath the sloped ceiling at a structural point of maximum heat trap and a canopy portion of the sidewall sprinklers deflector is generally parallel to the ceiling; and
coupling a piping system to each sprinkler by a plurality of branch lines sized to provide each sprinkler with the hydraulic demand substantially equivalent to a projection hydraulic demand for a horizontal footprint projection of the sloped ceiling on the floor.
